(19) United States
(12) Patent Application Publication
(10) Pub. No.: US 2013/0227681 A1
(43) Pub. Date: Aug. 29, 2013

(54) SYSTEM, APPARATUS, AND METHOD FOR VERIFYING AUGMENTED REALITY SERVICE

(71) Applicant: Jin-Hyun HONG, Seoul (KR)

(72) Inventor: Jin-Hyun HONG, Seoul (KR)

(73) Assignee: Pantech Co., LTD., Seoul (KR)

(21) Appl. No.: 13/551,885

(22) Filed: Jul. 18, 2012

(30) Foreign Application Priority Data
Feb. 24, 2012 (KR) 10-2012-0019291

(51) Int. Cl. G06F 21/00

(52) U.S. Cl. 726/22

(57) ABSTRACT

A system for the verifying the security of information provided to an augmented reality service includes a terminal and a server. The terminal collects information about an object and transmits the object information to the server. The server transmits tag information related to the object information to the terminal. The terminal determines if the tag information includes harmful information. If the tag information includes harmful information, the terminal may process the harmful information with a vaccine or transmit the tag information to the server for processing. The terminal displays the object information and tag information according to a user settings related to the display of tag information including harmful information.

### CROSS-REFERENCE TO RELATED APPLICATION

This application claims priority from and the benefit under 35 U.S.C. §119(a) of Korean Patent Application No. 10-2012-0019291, filed on Feb. 24, 2012, which is incorporated by reference for all purposes as if fully set fort h herein.

### BACKGROUND

1. Field

The following description relates to an augmented reality service technology, and more particularly, to a system, an apparatus, and a method for verifying the security of information provided to an augmented reality service.

2. Discussion of the Background

Augmented reality (AR) refers to a computer graphics technique of synthesizing a virtual object or information with a real environment and thus enabling the virtual object or information to be displayed as if it was an object that exists in the real environment.

Unlike virtual reality which targets only a virtual space or virtual things, AR synthesizes a virtual thing on the basis of the real world and thus may provide additional information that may be difficult to obtain in the real world. AR can be applied to various real environments, and is attracting attention as a next generation display technology suitable for a ubiquitous environment. AR technology may include receiving text-based tag information about a specific object from a server and displaying the received information.

With the development of AR technology, users may personally register tag information about an object using a method such as geo-tagging, and registration information may be expanded from simple text-based information to files such as photos, videos, and text including hyperlinks.

However, the use of photo files, video files, and text with hyperlinks may increase the vulnerability of these rich-media files to malicious codes that may be spread to other devices. For example, a script executing malicious code may be inserted into a file, and then the file may be disguised and distributed as a normal file. A personal computer (PC) can be infected with the malicious code if a user that has received a file connects to a phishing site through a hyperlink. This may cause the loss of personal information, or the PC may become a zombie PC and attack another user's PC or be used for a DDos attack and the like.

If tag information for an AR service does not undergo verification for security, it may have a malicious code inserted thereinto, may be transmitted from a server, a terminal, etc. A terminal that receives tag information may not be able to protect a user's personal information, etc. without verifying the security of the tag information.

### SUMMARY

Exemplary embodiments of the present invention provide an apparatus and a method for verifying the security of tag information received by a terminal.

Exemplary embodiments of present invention also provide an apparatus and a method for sorting tag information according to data attributes, and allowing security verification to be performed according to a verification method corresponding to the kind of the sorted tag information.

Exemplary embodiments of present invention also provide an apparatus and a method for displaying the security verification operation and security verification result of tag information via a user interface.

Additional features of the invention will be set forth in the description which follows, and in part will be apparent from the description, or may be learned by practice of the invention.

An exemplary embodiment of the present invention discloses an apparatus to verify an augmented reality (AR) service, including: an object information collector configured to collect information about an object; a communicator configured to transmit object information and to receive tag information; a controller configured to verify the security of the tag information; and a display to display the verified tag information and the object information.

An exemplary embodiment of the present invention also discloses a method for verifying the security of tag information in an augmented reality (AR) service, including: collecting object information about an object; searching for tag information associated with the object information; determining if the tag information includes harmful information; and if the tag information is determined to include harmful information, generating verified results of the tag information, and generating an AR service according to the verified tag information.

An exemplary embodiment of the present invention also discloses a system for verifying security, including: a terminal configured to collect object information and transmit the object information, to receive tag information related to the object information, to verify the security of the tag information, to generate verified result of the security of the tag information, and to process the verified result; and a server to receive the object information from the terminal and to transmit tag information to the terminal.

An exemplary embodiment of the present invention also discloses a method of verifying tag information, including: determining if a verification record exists for the tag information; if no verification record exists, determining if harmful information is included in the tag information; if harmful information is included in the tag information, processing the tag information.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a system for verifying security of an augmented reality (AR) service according to an exemplary embodiment of the present invention.

FIG. 2 is a diagram illustrating a user interface screen according to an exemplary embodiment of the present invention.

FIG. 3 is a diagram illustrating a user interface screen according to an exemplary embodiment of the present invention.

FIG. 4 is a diagram illustrating a user interface screen according to an exemplary embodiment of the present invention.

FIG. 5 is a diagram illustrating a storage according to an exemplary embodiment of the present invention.

FIG. 6A is a diagram illustrating a setting menu item on a user interface screen according to an exemplary embodiment of the present invention.

FIG. 6B is a diagram illustrating a setting menu item on a user interface screen according to an exemplary embodiment of the present invention.

FIG. 6C is a diagram illustrating a setting menu item on a user interface screen according to an exemplary embodiment of the present invention.

FIG. 6D is a diagram illustrating a setting menu item on a user interface screen according to an exemplary embodiment of the present invention.

FIG. 7 is a flowchart of a method for verifying the security of tag information of an AR service according to an exemplary embodiment of the present invention.

FIG. 8 is a flowchart of a tag information verification operation of FIG. 7.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of regions may be exaggerated for clarity. Like reference numerals in the drawings denote like elements.

It will be understood that when an element or layer is referred to as being “on” or “connected to” another element, it can be directly on or directly connected to the other element, or intervening elements may be present. In contrast, when an element is referred to as being “directly on” or “directly connected to” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

An object refers to a thing or a state that exists in the real world, and may include data that may be perceived in the real world, such as position data, climate data, speed data, visual data, auditory data, olfactory data, etc. Tag information or object-related tag information refers to information associated with the object, for example, if the object is the Louvre museum, the tag information may include architectural information on the Louvre museum, a video of art work housed in the Louvre museum, viewing guides, sound, etc. Augmented reality (AR) information refers to information in which the object and the tag information have been synthesized, and refers to information that may be provided to a user of an AR service. Security may refer to determining whether malicious code, other malicious material, errors, etc. are present in data.

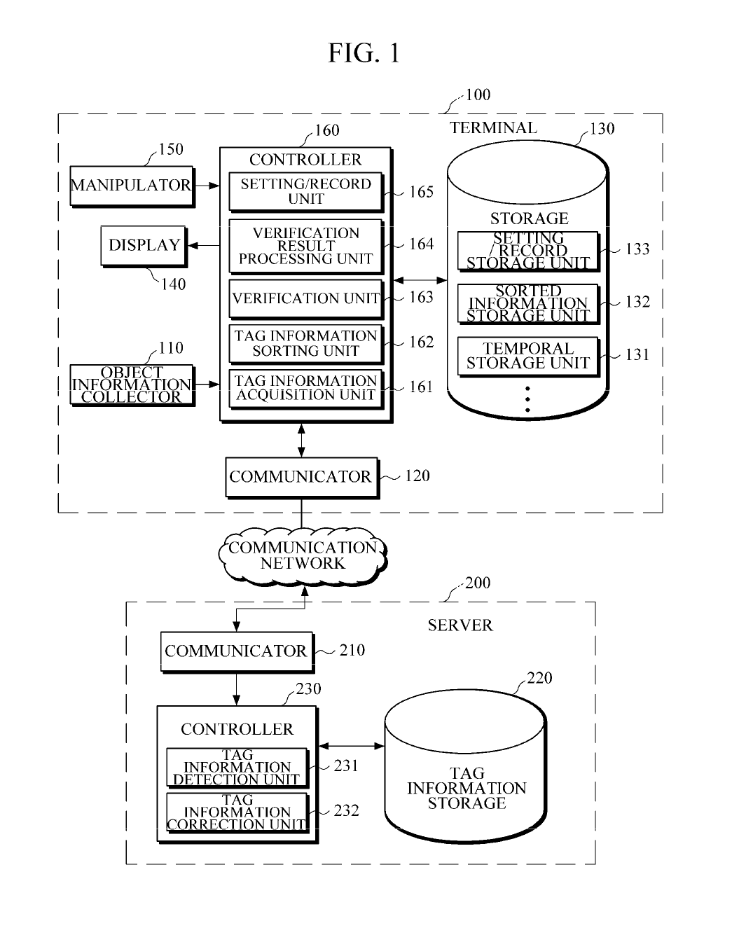

FIG. 1 is a diagram illustrating a system of verifying security of an AR service according to an exemplary embodiment of the present invention.

Referring to FIG. 1, one or more AR provision terminal apparatus (hereinafter referred to as a “terminal”) 100 is connected to an AR provision server apparatus (hereinafter referred to as a “server”) 200 which may be configured to provide an AR service to the terminal 100, over a communication network. The communication network may be a wired or wireless network.

The terminal 100 may be a mobile communication terminal, (e.g., a personal digital assistant (PDA), a smart phone, and a navigation terminal,) or personal computer (e.g., desktop computers, notebook computers, tablet computers, etc.). The terminal 100 may be used with any device that displays information with object-related tag information synthesized therein or AR information including tag information.

The terminal 100 includes an object information collector 110, a communicator 120, a storage 130, a display 140, a manipulator 150, and a controller 160.

The object information collector 110 may be configured to collect information about one or more objects of interest. The object information collector 110 may include at least one of a camera or an image sensor, a microphone, an olfactory data sensor, a global positioning system (GPS) position sensor, a geomagnetic sensor, a speed sensor, etc.

The communicator 120 may be configured to process a signal that may be outputted by the terminal 100 and a signal that may be received from the communication network. The communicator 120 may transmit object information collected by the object information collector 110 to the server 200. The communicator 120 may receive object-related tag information from the server 200, and output the received tag information to the controller 160.

The storage 130 may be configured to store information that is transmitted from the server 200 and received by the communicator 120. The storage 130 includes a temporal storage unit 131 configured to temporarily store tag information received from the server 200, and a sorted information storage unit 132 configured to store information in which the tag information temporarily stored in the temporal storage unit 131 has been sorted according to data attributes. The storage 130 may further include a setting/record storage unit 133 configured to store information about the tag information and/or the AR application, such as verification setting information, verification history, verification result display, or processing history.

The display 140 may be a display device configured to displays the state of a device or the progress of a program according to a control signal from the controller 160. The display device may be a liquid crystal display (LCD), or any other display device. The display 140 may display tag information that has been verified and a verified state.

The manipulator 150 may be an interface configured to receive user information. The manipulator 150 may include a key input unit that generates key data each time a key button is pushed, a touch screen, a mouse, etc. Although, the display 140 and the manipulator 150 are depicted separately in FIG. 1, aspects of the present invention are not limited thereto and the display 140 and the manipulator 150 may be integrated, for example, as a touch screen.

The controller 160 may be configured to control the above-described elements, and verify the security of object-related tag information. The controller 160 may be a hardware processor, or a software module that is executed in the hardware processor.

The controller 160 may include a tag information acquisition unit 161, a tag information sorting unit 162, a verification unit 163, a verification result processing unit 164, and a setting/record unit 165.

The tag information acquisition unit 161 may be configured to control object information collected by the object information collector 110 and to control the transmittal of the object information to the server 200 via the communicator 120. The tag information acquisition unit 161 may receive object-related tag information that is transmitted from the server 200 via the communicator 120, and may store the received tag information in the storage 130. The tag information acquisition unit 161 may temporarily store tag information in the temporal storage unit 131 of the storage 130, irrespective of the data attribute of the tag information. The temporarily stored tag information may be stored in a file type storage system.

The tag information sorting unit 162 may be configured to sort the tag information, stored in the temporal information storage unit 131 according to data attributes and store the sorted information in the sorted information storage unit 132. The tag information may be sorted according to one of a photo file or a video file, text information without a hyperlink, and text information including a hyperlink. If the tag information is sorted, a verification method according to an information type may be used, and may thereby reduce verification time. For example, a verification method for a file may include determining whether a malicious code is included in the file, and a verification method for a phishing site may include determining whether a linked URL is a phishing site. In other words, malicious code information or linked URL information vulnerable to security breach may be pre-stored. If tag information is a file, whether at least one of a plurality of codes included in the file matches the pre-stored malicious code vulnerable to security breach may be determined. If the tag information includes a hyperlink, whether a URL matches the pre-stored URL vulnerable to security breach is determined. If tag information is text information without a hyperlink, the frequency of a search for the tag information may be used as a verification method. The text information without a hyperlink may be personal information that has been uploaded by a user or other text information. The reliability of the text information without a hyperlink may be determined according to the frequency of a search that is performed by other users for the text information. Tag information may be sorted before the verification of security. If tag information includes the reliability of text information according to the frequency of a search for the tag information, there may be a time saving in the verification process because the reliability may have already been determined.

For example, the tag information sorting unit 162 may determine whether a header is included in temporarily-stored tag information. Tag information including a header may be determined to be a file. The kind of a file may be determined according to signature information included in a header of the file. A photo file or a video file may be sorted first. By checking tag information which is left after being sorted according to a file (i.e., tag information that is not a file), the tag information sorting unit 162 may determine the remaining tag information includes hyperlinks and may determine whether link information including a type such as HTML (if for example, the tag information includes a character string of “<a href=”). Thus, the tag information sorting unit 162 may determine whether the tag information is tag information including a hyperlink. If the tag information sorting unit 162 determines the tag information does not include a hyperlink, the tag information sorting unit 162 may determine the tag information is text information without a hyperlink.

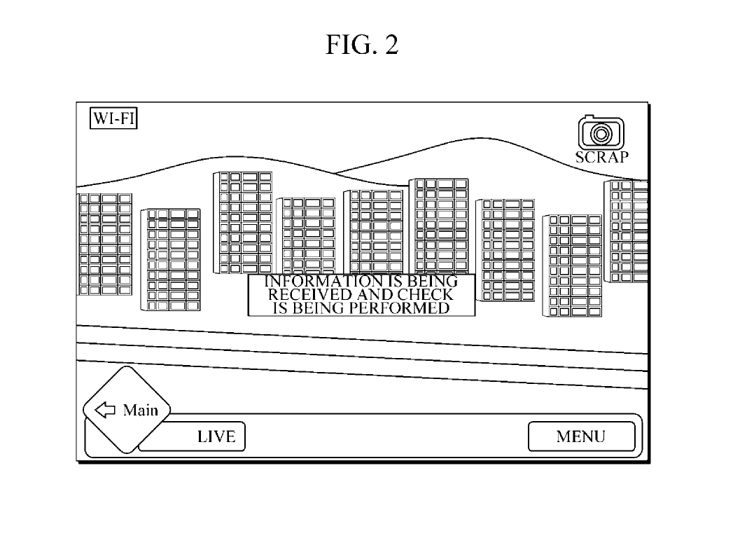

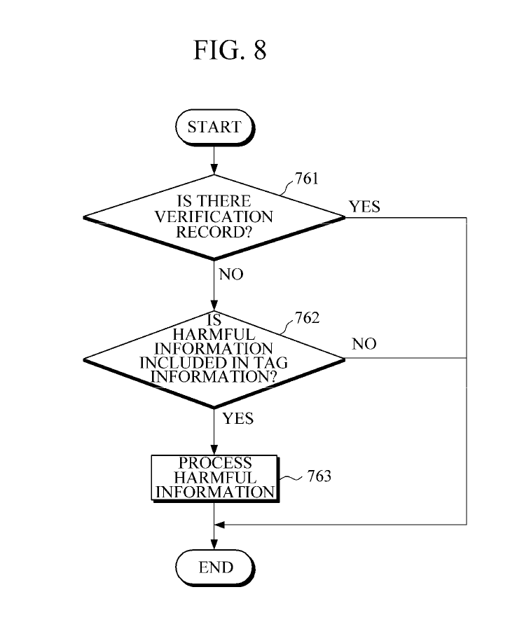

The verification unit 163 is configured to verify the tag information that is stored in the storage 130. In detail, the verification unit 163 may verify tag information by performing a verification method corresponding to the data attribute of the tag information that is sorted and stored in the sorted information storage unit 132. The verification unit 163 may perform verification on the basis of the verification setting information that is stored in the setting/record storage unit 133. The verification unit 163 may control the display of a User Interface (UI) on the display 140, the UI may display a verification method being performed. FIG. 2 is a diagram illustrating a UI screen according to an exemplary embodiment of the present invention. Referring to FIG. 2, the UI screen may display a tag information verification screen. The verification unit 163 may filter tag information on the basis of previously-searched records in the setting/record storage unit 133. The filtering of tag information may not be a verification of the tag information. Accordingly, a verification processing speed may be increased by the filtering of tag information. The verification unit 163 will be described in more detail below with reference to FIG. 8.

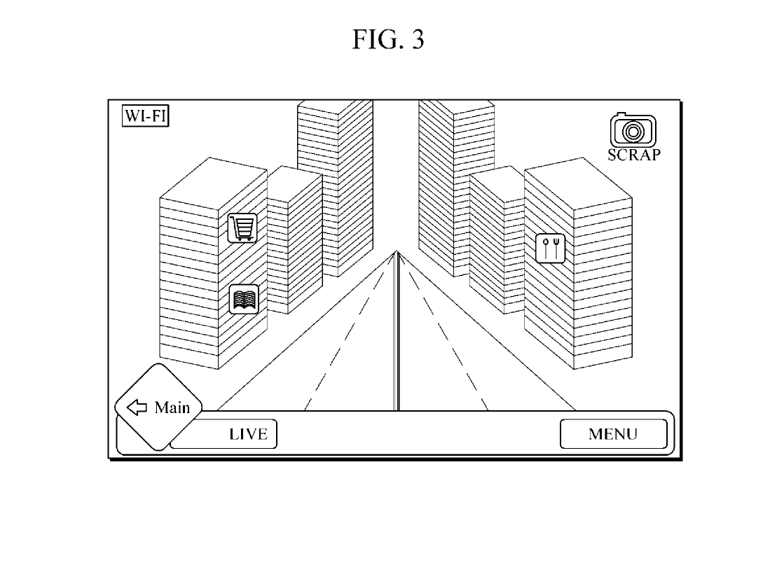

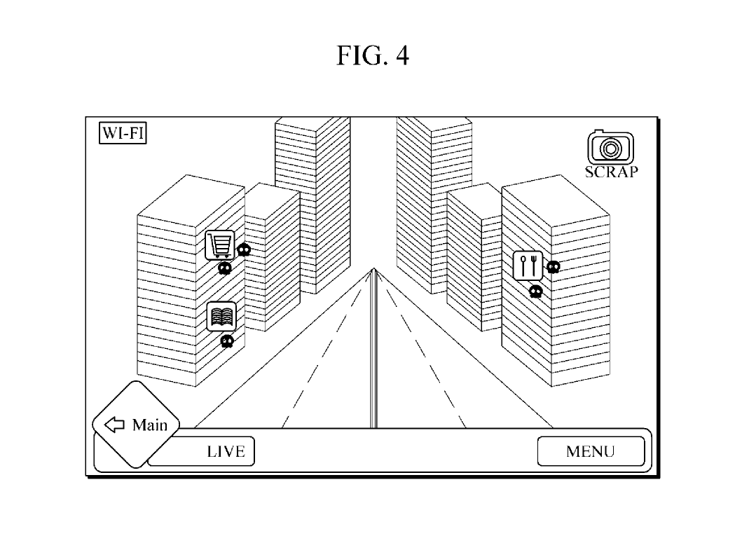

The verification result processing unit 164 may be configured to process a verified result on the basis of the verification setting information that is stored in the setting/record storage unit 133. A verified result may be a captured image of the tag information. The verification result processing unit 164 may display harmful tag information with various types of UIs according to the settings of terminal 100. If tag information is determined to be harmful by a verified result, the verification result processing unit 164 may replace the harmful tag information (which may be stored in the setting/record storage unit 133) with a captured image of the harmful tag information. This will be described in more detail below with reference to FIG. 3 and FIG. 4.

FIG. 3 is a diagram illustrating a UI screen according to an exemplary embodiment of the present invention.

Referring to FIG. 3, a tag that indicates a shopping center, a restaurant, or the like is marked on buildings displayed on a UI. If tag information is verified as including harmful information, the verified result may be displayed.

FIG. 4 is a diagram illustrating a UI screen according to an exemplary embodiment of the present invention.

Referring to FIG. 4, tag information is displayed with an indicator of security, such as, a symbol to indicate security according to the degree of security of the tag information, e.g., the degree of harmful information in tag information. In FIG. 4, the indicator of security is a skull symbol and an increasing degree of security risk of tag information may be displayed with an increasing number of skulls. However, the degree of security may be displayed by other methods, for example, by the use of different colors, by adjusting brightness of tag information, etc.

Referring again to FIG. 1, the verification result processing unit 164 may transmit captured images of harmful tag information, which may be obtained by a verification operation of AR information, to the server 200 or other terminals of users that are located nearby thereby sharing information about the harmful tag information.

A terminal that receives a list of harmful tag information from another terminal or server may use the list as a reference or a filter if using an AR application.

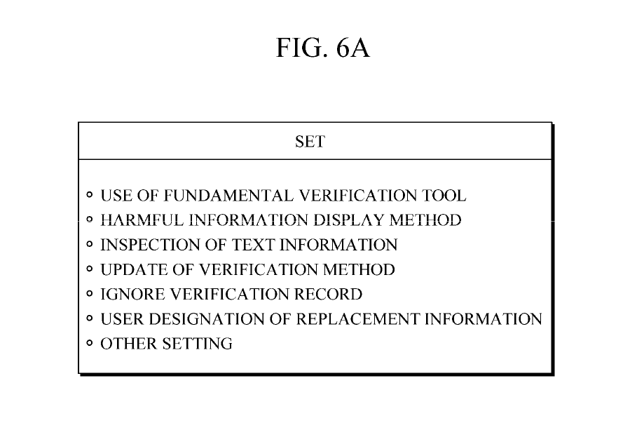

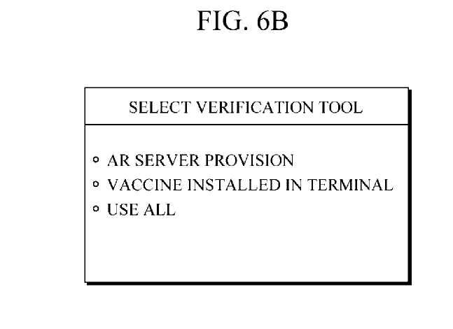

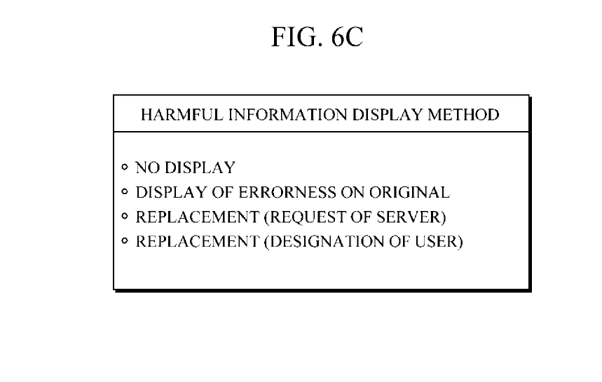

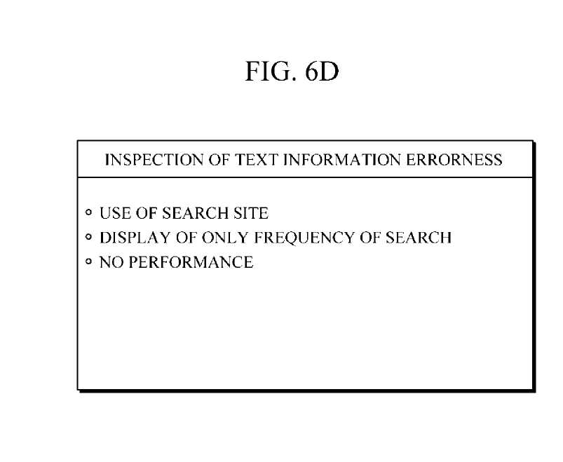

The setting/record unit 165 may be configured to receive a user setting value for verification, a verification record, and an AR application setting value, and may store the received values and records in the setting/record storage unit 133. Information stored by the setting/record unit 165 may be information that is set by a manufacturer, or information that is designated by a user with the manipulator 150. This will be described in more detail below with reference to FIG. 6A, FIG. 6B, FIG. 6C, and FIG. 6D.

The server 200 includes a communicator 210, a tag information storage 220, and a controller 230.

The communicator 210 is configured to process an output signal and a signal that is received from communication network. The communicator 210 may be configured to receive and process object information transmitted from the terminal 100 and to output the processed information to the controller 230. The communication 210 may be configured to process tag information corresponding to the object from the controller 230 and to transmit the processed information to the terminal 100.

The tag information storage 220 may be configured to store tag information, and moreover may include information about the frequency of a search for tag information. The tag information storage 220 may also include verification information. For example, security may be divided into high, medium, and low levels and stored, or stored by accumulating the number of stable verifications of the tag information.

The controller 230 includes a tag information detection unit 231 and a tag information correction unit 232.

If the detection of tag information is requested by the terminal 100, the tag information detection unit 231 is configured to detect tag information corresponding to a received object. The tag information detection unit 231 may detect an identifier (ID) corresponding to received tag information, and may detect tag information having the detected ID from the tag information storage 220 to generate information to be transmitted to the terminal 100. The generated information may include both tag information and the frequency of search of the tag information.

The tag information correction unit 232 may be configured to receive a verified result of tag information that has been transmitted from the terminal 100 and received by the communicator 210, and may update data in the tag information storage 220.

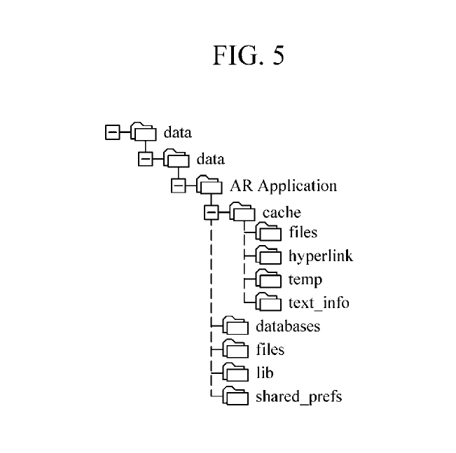

FIG. 5 is a diagram illustrating a storage according to an exemplary embodiment of the present invention.

Referring to FIG. 5, a data folder associated with an AR application includes a plurality of folders such as “cache,” “databases,” “files,” “lib,” and “shared_prefs.”

The “cache” may be a space in which tag information received from the server 200 may be stored, and may include a “temp folder” corresponding to the temporal storage unit 131, and “files,” “text_info,” “temp,” and “hyperlink” folders that correspond to the sorted information storage unit 132. Tag information including a photo file or a video file may be stored in the “files” folder, tag information including a hyperlink may be stored in the “hyperlink” folder, and tag information including text information without a hyperlink may be stored in the “text_info” folder.

The “databases” may be a space in which setting values for verification, user setting values associated with the AR application, and search-related records may be stored. The databases may correspond to the setting/record storage unit 133 of FIG. 1. The “files” may be a space in which files that are used in the AR application are stored. The “lib” may be a space in which information about a verification method that may be used in the AR application is stored. The “shared_prefs” may be a space in which user preferences for the AR application are stored. The “preferences” may refer to menu item information that is set by a user for the tag information verification.

FIG. 6A is a diagram illustrating a setting menu item on a UI screen according to an exemplary embodiment of the present invention. FIG. 6B is a diagram illustrating a setting menu item on a UI screen according to an exemplary embodiment of the present invention. FIG. 6C is a diagram illustrating a setting menu item on a UI screen according to an exemplary embodiment of the present invention. FIG. 6D is a diagram illustrating a setting menu item on a UI screen according to an exemplary embodiment of the present invention. FIG. 6A, FIG. 6B, FIG. 6C, and FIG. 6D illustrate UIs that may be displayed as a user selects settings via the manipulator 150. The UIs of FIG. 6A, FIG. 6B, FIG. 6C, and FIG. 6D may correspond to the operation of the setting/record unit 165 of FIG. 1.

If a setting request is selected by a user using the manipulator 150, the setting/record unit 165 may output a menu screen illustrated in FIG. 6A.

Referring to FIG. 6A, the “USE OF FUNDAMENTAL VERIFICATION TOOL” may be used for selecting which verification method is to be used if the security of tag information is to be verified according to information-sorted data attributes. The “USE OF FUNDAMENTAL VERIFICATION TOOL” may include sub menu items illustrated in FIG. 6B, which may include “AR SERVER PROVISION,” “VACCINE INSTALLED IN TERMINAL,” and “USE ALL.” Referring again to FIG. 6A, if “USE OF FUNDAMENTAL VERIFICATION METHOD” is selected, the setting/record unit 165 may select to perform verification using at least one of a vaccine included in a verification tool provided from the server 200 and a vaccine installed in the terminal 100.

Referring to FIG. 6B, if “AR SERVER PROVISION” is selected, the setting/record unit 165 may select a data attribute of tag information to verify using a verification method provided from the server 200. For example, the verification method provided from the server 200 may include a method for verifying the security of text information without a hyperlink. A verification method provided from the server 200 may be automatically updated periodically. A user may update the verification method provided by the server 200 by selecting an item “UPDATE OF VERIFICATION METHOD” as illustrated in FIG. 6A.

Referring again to FIG. 6B, if “VACCINE INSTALLED IN TERMINAL” is selected, the setting/record unit 165 may select a tag information sorting type to verify a vaccine installed in the terminal 100. For example, a file and a hyperlink may each be a tag information sorting type to verify the vaccine installed in the terminal 100.

If “USE ALL” is selected, the setting/record unit 165 may select a tag information sorting type that uses both the verification method provided from the server 200 and the vaccine installed in the terminal 100 as verification methods.

Referring again to FIG. 6A, “HARMFUL INFORMATION DISPLAY METHOD” may be used for selecting a method for processing information which determines a verified result in a UI. “HARMFUL INFORMATION DISPLAY METHOD” may include a sub menu illustrated in FIG. 6C, and the sub menu may include “NO DISPLAY,” “DISPLAY OF SECURITY OF ORIGINAL,” “REPLACEMENT (REQUEST OF SERVER),” and “REPLACEMENT (DESIGNATION OF USER).”

Referring to FIG. 6C, if “NO DISPLAY” is selected from the UI screen, an indicator of harmful information may not be displayed on a UI screen, and the verification result processing unit 164 may be configured to not display harmful information. If “DISPLAY OF SECURITY ON ORIGINAL” is selected, both original information and security information may be displayed, and the verification result processing unit 164 may be configured to display both harmful information and the original information. As illustrated in FIG. 4, the harmful information may be displayed together with the original information. If “REPLACEMENT (REQUEST OF SERVER)” is selected, the verification result processing unit 164 may display replacement tag information from the server 200. If “REPLACEMENT (DESIGNATION OF USER)” is selected, the verification result processing unit 164 may displays security information as designated by a user.

Referring again to FIG. 6A, if “USER DESIGNATION OF REPLACEMENT INFORMATION” is selected from the UI screen, a user may designate an image or content for display according to a characteristic of tag information. The user may designate an image or text stored in the terminal 100 with the item “REPLACEMENT INFORMATION USER DESIGNATION.” The selected image or text may be used in the AR application, and stored in the files folder of the storage 130 illustrated in FIG. 5.

Referring again to FIG. 6A, “INSPECTION OF TEXT INFORMATION SECURITY” may be used for selecting a method for verifying text information. “INSPECTION OF TEXT INFORMATION SECURITY” may have a sub menu items illustrated in FIG. 6D, and the sub menu may include “USE OF SEARCH SITE,” “DISPLAY OF ONLY FREQUENCY OF SEARCH,” and “NO PERFORMANCE.”

Referring to FIG. 6A, “IGNORE PREVIOUS VERIFICATION RECORD” may be used to select whether to ignore a previously-verified record and perform a new verification, or use the previously-verified record as is. “OTHER SETTING” may be used for setting various other settings for the operation of the AR application.

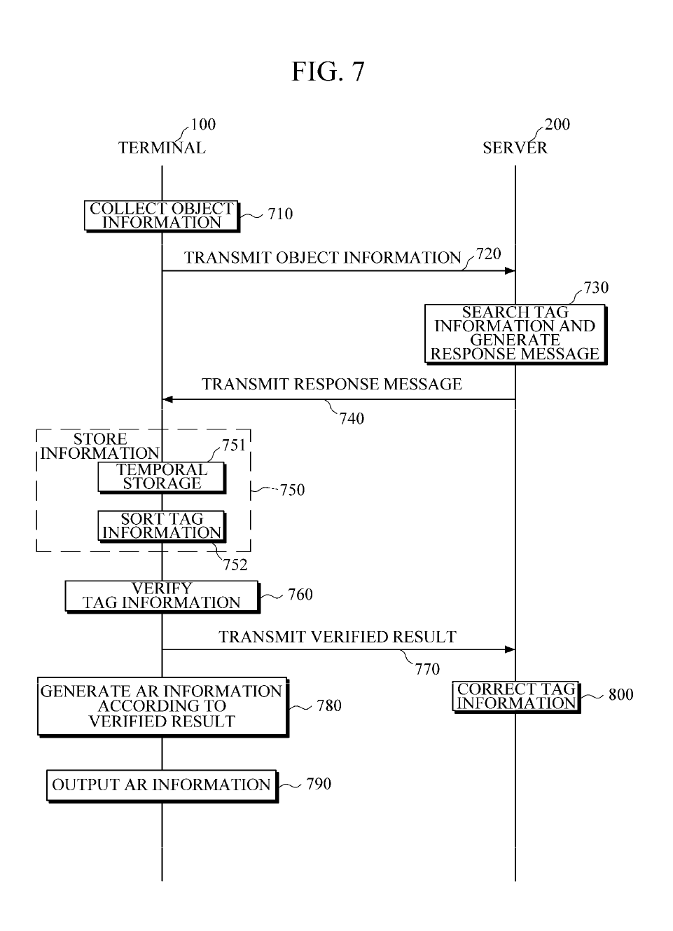

A method for verifying AR information in the system for providing AR will now be described with reference to FIG. 7 and FIG. 8.

FIG. 7 is a flowchart of a method for verifying the security of tag information of an AR service according to an exemplary embodiment of the present invention. The method of FIG. 7 and FIG. 8 will be described as if performed by the system of FIG. 1, but is not limited thereto.

Referring to FIG. 7, in operation 710, the terminal 100 collects object information. In other words, the terminal 100 collects information about an object that may include position data, climate data, speed data, visual data, auditory data, olfactory data, etc. about the selected object.

In operation 720, the terminal 100 transmits the collected object information to the server 200 and requests object-related tag information via the communication network.

In operation 730, the server 200 searches for tag information corresponding to the received object and generates a response message to be transmitted to the terminal 100. The response message may include the object-related tag information and information about the frequency of a search for the tag information of the selected object. In operation 740, the server 200 transmits the generated response message to the terminal 100 via the communication network.

In operation 750, the terminal 100 stores information included in the response message.

In operation 751, the terminal 100 may temporarily store the information from the response message in the temporal storage unit 131. In operation 752, the terminal 100 may sort and store the tag information from the response message in the temporarily-stored information according to data attributes of the tag information. The tag information may be sorted according to one of a photo file or a video file, text information without a hyperlink, and text information including a hyperlink, etc. The terminal 100 may determine whether temporarily-stored tag information includes a header. Tag information including a header may be determined to be a file. Furthermore, the type of file may be determined according to the signature information included in a header of the file. A photo file or a video file may be sorted first. The tag information sorting unit 162 may determine whether the remaining tag information (i.e., tag information that is determined not to be a photo file or a video file) includes link information, for example by determining if the tag information includes a character string of HTML (i.e., “<a href =”). The tag information sorting unit 162 may then determine the remaining tag information is text information without a hyperlink.

In operation 760, the terminal 100 verifies the security of the tag information. Security may be verified by a verification method corresponding to the data attributes of the sorted and stored tag information. Verification may be performed on the basis of verification setting information that is stored in the setting/record storage unit 133. The terminal 100 may display a UI so that a user may view the performance of the verification method. An operation of verifying security will be described in more detail below with reference to FIG. 8.

In operation 770, the terminal 100 transmits the verified results of operation 760 the verification of security of tag information to the server 200. The verified results may include harmful information, which may be obtained in an operation of verifying AR information. The transmittal of harmful information to the server 200 or other terminals may enable the sharing of the harmful information for verification of security of the harmful information, harmful information processing, etc. The terminal 100 may transmit the verified results to nearby terminals via the communication network, which may include mobile hotspots, WiFi, WiMax, WiBro, etc.

In operation 780, the terminal 100 generates AR information to be displayed on the display 140 of the terminal 100, according to the verified result of operation 760. The terminal 100 may processes the verified result on the basis of the verification setting information stored in the setting/record storage unit 133. The terminal 100 may synthesize a captured image and the verified result of tag information related to the captured image. Original information may be displayed as is. Tag information determined to be secure according to the verified result may be displayed as is. If tag information is determined to be harmful information, it is determined whether to display the harmful information or perform a separate processing of the harmful information. The harmful information may be displayed according to a value that has been selected in the menu “HARMFUL INFORMATION DISPLAY METHOD” of FIG. 6A which may correspond to the setting/record storage unit 133. If a separate processing of the harmful information is performed, the terminal 100 may send a request to the server 200 to receive information to be replaced with the harmful information, or the terminal 100 may use an icon or a mark from the AR application to denote the harmful information. The terminal 100 may use information that has been selected in the menu “REPLACEMENT (REQUEST OF SERVER)” of FIG. 6C which may correspond to the setting/record storage unit 133 to denote harmful information. The terminal 100 may display tag information according to the degree of security of the tag information. The terminal 100 may allow a user to determine the security of the tag information by viewing the display of tag information. For example, as illustrated in FIG. 4, the degree of security may be displayed by the number of security icons (i.e., skull icons), different colors, or adjustment of brightness of tag information.

Referring again to FIG. 7, in operation 790, the terminal 100 outputs generated AR information. In operation 800, the server 200 corrects the degree of security of stored tag information according to the verified result transmitted from the terminal 100.

FIG. 8 is a flowchart of a tag information verification operation of FIG. 7.

In operation 761, the terminal 100 searches the setting/record storage unit 133 to determine if there is a record in which the security of the same object has been previously verified.

If operation 761 shows that there is a security verification result for the tag information, the terminal 100 does not perform operation 760 of FIG. 7 and proceeds to operation 770 of FIG. 7. This, for example, is because it is unnecessary to perform re-verification if the terminal 100 has already verified the tag information. By not performing the verification operation 760, the time taken to perform verification may be shortened.

If the result of operation 761 shows that there is no security verification result for the tag information, in operation 762, the terminal 100 determines if harmful information is included in the tag information.

A vaccine installed in the terminal 100 or a verification method provided from the server 200 may be used according to data attributes of tag information in a verification method used in operation 762.

For example, if tag information includes a hyperlink, the terminal 100 may compare the hyperlink with a list of harmful hyperlinks, or may determine whether the tag information is harmful on the basis of the frequency of search information for the tag information received from the server 200. If the tag information is text information without a hyperlink, the terminal 100 may verify security of the tag information using a tag information search site, such as Flickr or may display the frequency of search for tag information to be displayed without the verification of security, according to a user setting value that is stored in the setting/record storage unit 133. In a photo file or a video file, a pattern verification technique that determines whether a signature or internal structure of the file has the same content or structure as a pattern of a previously-found malicious code may be used.

If the result determined in operation 762 shows that the tag information does not include harmful information, the terminal 100 proceeds to operation 770.

In operation 763, the terminal 100 processes the harmful information if the tag information is determined to include harmful information in operation 762.

Various methods for processing the harmful information may be used. For example, the terminal 100 may transmit tag information to the server 200 to request a treatment for the harmful information, and thus may receive treated tag information. Tag information may be processed with a vaccine stored in the terminal 100. Referring again to FIG. 7, in operation 780, the terminal 100 may allow the degree of security to be displayed without treating tag information according to data attributes of the tag information.

According to exemplary embodiments of the present invention, by verifying the security of tag information received by a terminal, a user's personal information and a terminal may be protected from malicious codes. Also, according to exemplary embodiments of the present invention, tag information may be sorted according to data attributes, and verification can be performed by a verification method corresponding to the kind of the sorted tag information, and may thereby increase the speed of the verification. Furthermore, the verification operation and verification result of the tag information may be displayed on the UI, and thus the user may perceive the security of the tag information.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus to verify an augmented reality (AR) service, comprising:
an object information collector configured to collect object information about an object;
a communicator configured to transmit the object information and to receive tag information;
a controller configured to verify the security of the tag information; and
a display to display the verified tag information and the object information.

2. The apparatus of claim 1, wherein the controller comprises:
a verification result processing unit configured to verify the security of tag information and to process a verified result of the verification of security of tag information.

3. The apparatus of claim 2, wherein the verification result processing unit is configured to verify the security of tag information according to a data type of the tag information.

4. The apparatus of claim 2, wherein if the verification result processing unit determines tag information includes harmful information, the verification result processing unit processes the harmful information.

5. The apparatus of claim 2, wherein the data types of the tag information are at least one of a photo file, a video file, a text file with hyperlink, and a text file without a hyperlink.

6. The apparatus of claim 2, wherein processing the harmful information comprises at least one of requesting the communicator transmit a request for treatment of the harmful information and processing harmful information with a vaccine.

7. The apparatus of claim 2, wherein the controller further comprises:
a setting/record unit configured to receive at least one of a user setting value, a verification record, and an AR application setting value.

8. The apparatus of claim 2, wherein the display is configured to display an indicator of the security of tag information according to the degree of security of the tag information.

9. A method for verifying the security of tag information in an augmented reality (AR) service, comprising:
collecting object information about an object;
searching for tag information associated with the object information;
determining if the tag information includes harmful information; and
if the tag information is determined to include harmful information, generating verified results of the tag information, and generating an AR service according to the verified tag information.

10. The method of claim 9, wherein determining if the tag information includes harmful information comprises:
verifying the security of the tag information according to a data type of tag information.

11. The method of claim 10, wherein the data type is at least one of a photo file, a video file, a text file with hyperlink, and a text file without a hyperlink.

12. The method of claim 11, further comprising sorting the tag information according to a data type, the data type being determined according to at least one of a header of the tag information or a character string included in the tag information.

13. The method of claim 9, wherein object information comprises at least one of position data, climate data, speed data, visual data, sound data, and olfactory data of the object.

14. The method of claim 9, wherein determining if the tag information includes harmful information comprises:
determining if a security verification record exists for the tag information;
if a security verification record does not exist, determining if harmful information is included in the tag information;
if harmful information is included in the tag information, processing the harmful information.

15. The method of claim 14, wherein processing the harmful information comprises at least one of transmitting a request for treatment of the harmful information and processing harmful information with a vaccine.

16. The method of claim 9, further comprising:
displaying the object information and an indicator of the security of tag information according to the verified results of the tag information.

17. A system for verifying security, comprising:
a terminal configured to collect object information and transmit the object information, to receive tag information related to the object information, to verify the security of the tag information, to generate a verified result of the security of the tag information, and to process the verified result; and
a server to receive the object information from the terminal and to transmit the tag information to the terminal.

18. The system of claim 17, wherein the processing of the verified result comprises at least one of transmitting the tag information to the server for processing and processing tag information with a vaccine.

19. A method of verifying tag information, comprising:
determining if a verification record exists for the tag information;
if no verification record exists, determining if harmful information is included in the tag information; and
if harmful information is included in the tag information, processing the tag information.

20. The method of claim 19, wherein the processing of tag information comprises at least one of transmitting the tag information for processing and processing harmful information with a vaccine.
